(19) United States
(12) Patent Application Publication
(10) Pub. No.: US 2015/0090226 A1
(43) Pub. Date: Apr. 2, 2015

(54) PROCESS FOR IMPROVING EFFICIENCIES OF GAS SYSTEMS USING A COMPRESSOR

(71) Applicant: BASF Corporation, Florham Park, NJ (US)

(72) Inventors: William Dolan, Yardley, PA (US); Christoph Garbotz, Mannheim (DE); Adam Lack, New York, NY (US); Joseph Lynch, Sparta, NJ (US); Stefan Marx, Dirmstein (DE); Ulrich Mueller, Neustadt (DE); Michael SantaMaria, Monmouth Junction, NJ (US); Mathias Weickert, Ludwigshafen (DE)

(21) Appl. No.: 14/498,363

(22) Filed: Sep. 26, 2014

Related U.S. Application Data
(60) Provisional application No. 61/883,603, filed on Sep. 27, 2013.
(60) Provisional application No. 61/883,669, filed on Sep. 27, 2013.
(60) Provisional application No. 61/883,704, filed on Sep. 27, 2013.

(51) Int. Cl. F02M 25/08; F02D 41/00

(52) U.S. Cl. CPC F02M 25/089; F02M 25/0854; F02D 41/003
USPC 123/445; 123/495; 29/897.2

(57) ABSTRACT

Disclosed in certain embodiments are methods of improving efficiencies of adsorbed gas fuel systems and to recover vapors from gasoline containers.

### CROSS REFERENCE TO RELATED APPLICATIONS

This application claims the benefit of priority of U.S. Provisional Patent Application No. 61/883,603, filed Sep. 27, 2013, U.S. Provisional Patent Application No. 61/883,669, filed Sep. 27, 2013, and U.S. Provisional Patent Application No. 61/883,704, filed Sep. 27, 2013, all of which are hereby incorporated by reference herein in their entireties.

### BACKGROUND OF THE DISCLOSURE

Adsorbent materials can be used for the storage of gas. A particular adsorbent, metal organic framework, is a highly crystalline structure with nanometer-sized pores that allow for the storage of natural gas and other gases such as hydrocarbon gas, hydrogen and carbon dioxide. Metal organic framework can also be used in other applications such as gas purification, gas separation and in catalysis.

These materials are typically in particle form and essentially consist of two types of building units: metal ions (e.g. zinc, aluminum) and organic compounds. Each of the organic compounds can attach to at least two metal ions (at least bidentate), serving as a linker for them. In this way a three dimensional, regular framework is spread apart containing empty pores and channels, the sizes of which are defined by the size of the organic linker.

The high surface area provided by metal organic framework can be used for many applications such as gas storage, gas/vapor separation, heat exchange, catalysis, luminescence and drug delivery. By way of example, metal organic framework can have (show) a specific surface area of up to 10,000 m²/g determined by Langmuir model.

A particular application of metal organic framework is for gas storage (e.g., natural gas) in gas powered vehicles. The larger specific surface area and high porosity on the nanometer scale enable metal organic framework to hold relatively large amounts of gases. Used as storage materials in natural gas tanks, metal organic framework offers a docking area for gas molecules, which can be stored in higher densities as a result. The larger gas quantity in the tank can increase the range of a vehicle. The metal organic framework can also increase the usable time of stationary gas powered applications such as generators and machinery.

The use of adsorbent material for gas storage in vehicles and other applications presents challenges to improve the overall outcome and efficiencies of the systems.

There exists a need in the art for systems and methods of providing adsorbed gas fuel systems (e.g., utilizing metal organic framework) that have increased efficiency and gas utilization.

### OBJECTS AND SUMMARY OF THE DISCLOSURE

It is an object of certain embodiments to provide systems for improved efficiencies of adsorbed gas systems.

It is an object of certain embodiments to provide systems for accessing gas from adsorbed gas systems during periods of low pressure.

It is an object of certain embodiments to provide systems to capture gas vapors escaping from gasoline in bi-fuel vehicles.

It is an object of certain embodiments to provide vehicles that incorporate the systems as disclosed herein.

The above objects and others, may be met by the present disclosure, which in certain embodiments is directed to an adsorbed gas fuel system including an internal combustion engine; an adsorbed gas container fluidly connected to the fuel injector, the adsorbed gas container containing adsorption particles; a compressor fluidly connected to the internal combustion engine and the adsorbed gas container, the compressor adapted to remove gas from the adsorbed gas container; and a control system to modulate the supply pressure (Pₑ) to the internal combustion engine.

Other embodiments are directed to a fuel system including: an internal combustion engine; an adsorbed gas container fluidly connected to the internal combustion engine, the adsorbed gas container containing an adsorbent; a gasoline container fluidly connected to the internal combustion engine and the adsorbed gas container; and a compressor capable of extracting gasoline vapor from the gasoline container and depositing the gasoline vapor into the adsorbed gas container.

In other embodiments, the present disclosure is directed to a fuel system including: an internal combustion engine; a gas container optionally fluidly connected to the internal combustion engine; a gasoline container fluidly connected to the internal combustion engine and the gas container; and a compressor capable of extracting gasoline vapor from the gasoline container and depositing the gasoline vapor into the gas container.

Additional embodiments are directed to a fuel system including: an internal combustion engine; an adsorbed gas container fluidly connected to the internal combustion engine, the adsorbed gas container containing an adsorbent; a gasoline container fluidly connected to the internal combustion engine and optionally the adsorbed gas container; an additional gas container and a compressor capable of extracting gasoline vapor from the gasoline container and depositing the gasoline vapor into the additional gas container.

In certain embodiments, the adsorption material utilized in the systems is metal organic framework.

Further embodiments are directed to a vehicle including a containment system as disclosed herein.

As used herein, the term “natural gas” refers to a mixture of hydrocarbon gases that occurs naturally beneath the Earth's surface, often with or near petroleum deposits. Natural gas typically includes methane but also may have varying amounts of ethane, propane, butane, and nitrogen.

The terms “adsorbed gas container” or “container suitable for adsorbed gas storage” refer to a container that maintains its integrity when filled or partially filled with an adsorption material that can store a gas. In certain embodiments, the container is suitable to hold the adsorbed gas under pressure or compression.

The terms “vehicle” or “automobile” refer to any motorized machine (e.g., a wheeled motorized machine) for (i) transporting of passengers or cargo or (ii) performing tasks such as construction or excavation. Vehicles can have, e.g., at least 2 wheels (e.g., a motorcycle or motorized scooter), at least 3 wheels (e.g., an all-terrain vehicle), at least 4 wheels (e.g., a passenger automobile), at least 6 wheels, at least 8 wheels, at least 10 wheels, at least 12 wheels, at least 14 wheels, at least 16 wheels or at least 18 wheels. The vehicle can be, e.g., a bus, refuse vehicle, freight truck, construction vehicle, heavy equipment, military vehicle or tractor. The vehicle can also be a train, aircraft, watercraft, submarine or spacecraft.

The term “activation” refers to the treatment of adsorption materials (e.g., metal organic framework particles) in a manner to increase their storage capacity. Typically, the treatment results in removal of contaminants (e.g., water, non-aqueous solvent, sulfur compounds and higher hydrocarbons) from adsorption sites in order to increase the capacity of the materials for their intended purpose.

The term “adsorbent material” refers to a material (e.g., adsorbent particles) that can adhere gas molecules within its structure for subsequent use in an application. Specific materials include but are not limited to metal organic framework, activated alumina, silica gel, activated carbon, molecular sieve carbon, zeolites (e.g., molecular sieve zeolites), polymers, resins and clays.

The term “particles” when referring to adsorbent materials such as metal organic framework refers to multiparticulates of the material having any suitable size such as 0.0001 mm to about 50 mm or 1 mm to 20 mm. The morphology of the particles may be crystalline, semi-crystalline, or amorphous. The term also encompasses powders and particles down to 1 nm. The size ranges disclosed herein can be mean or median size.

The term “monolith” when referring to absorbent materials refers to a single block of the material. The single block can be in the form of, e.g., a brick, a disk or a rod and can contain channels for increased gas flow/distribution. In certain embodiments, multiple monoliths can be arranged together to form a desired shape.

The term “fluidly connected” refers to two components that are arranged in such a manner that a fluid (e.g., a gas) can travel from one component to another component either directly or indirectly (e.g., through other components or a series of connectors).

The term “freely settled density” or “bulk density” is determined by measuring the volume of a known mass of particles. The measurement can be determined using the procedures described in Method I or Method II of the United States Pharmacopeia 26, section <616>, hereby incorporated by reference.

The term “tapped density” is determined by measuring the volume of a known mass of particles after agitating the materials or container or using any of the filling techniques disclosed herein. The measurement can be determined by modifying procedures described in Method I or Method II of the United States Pharmacopeia 26, section <616>, hereby incorporated by reference. The procedures therein can be modified to provide a “tapped density” after any physical manipulation of the container and/or particles, e.g., after vibrating the container or using the filling techniques as disclosed herein. The measurement can also be determined using modification of DIN 787-11 (ASTM B527).

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment, “certain” embodiments, or “some” embodiments in this disclosure are not necessarily to the same embodiment, and such references mean at least one.

FIG. 1 depicts a fuel system of an embodiment of the disclosure that utilizes a compressor to extract adsorbed gas from a container;

FIG. 2 depicts a control system for a fuel system of an embodiment of the disclosure that utilizes a compressor to extract adsorbed gas from a container;

FIG. 3 depicts a fuel system of an embodiment of the disclosure that utilizes a compressor to recover vapor from a gasoline container;

FIG. 4 depicts a fuel system of an alternate embodiment of the disclosure that utilizes a compressor to recover vapor from a gasoline container;

FIG. 5 is a flow diagram illustrating a method for implementing a fuel system in accordance with an embodiment of the disclosure.

### DETAILED DESCRIPTION

Adsorption materials (e.g., metal organic framework) are capable of storing large amount of gas for subsequent use in applications such as gas powered vehicles. When the containers that hold the adsorbent materials are depressurized as a result of consumption of the gas contained therein, a significant amount of the gas can remain adsorbed on the materials. As vehicles require high pressures for operation (e.g., a fuel injector may require pressures, e.g., of greater than about 150 psi, or 500 psi or more) the adsorbed gas at low pressures is not accessible to fuel the engine. This results in an inefficient utilization of fuels which is addressed by certain embodiments disclosed herein.

Another efficiency and environmental issue associated with gasoline powered vehicles and bi-fuel vehicles (e.g., running on both gasoline and compressed or adsorbed gas) is the emission of vapors from the gasoline, especially on hot days. This vapor is an environmental concern as well as an efficiency issue as the vapors are entering the environment unutilized. This concern is addressed by certain embodiments disclosed herein.

### Compressor Extraction of Adsorbed Gas

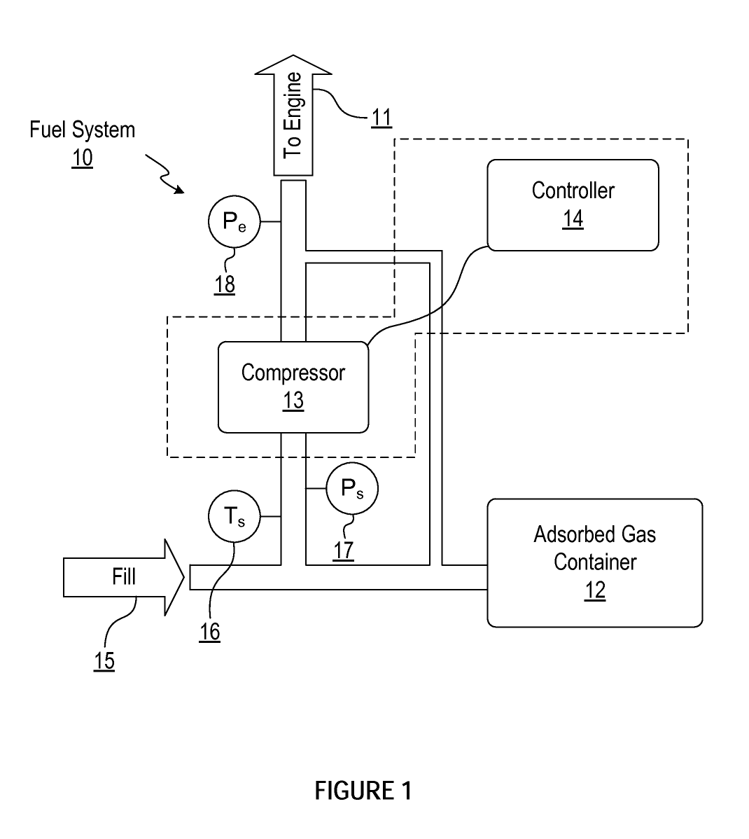

As depicted in FIG. 1, one embodiment is directed to an adsorbed gas fuel system (10) including an outlet (11) that may be fluidly connected to an internal combustion engine, an adsorbed gas container (12) containing adsorption particles and being fluidly connected to the internal combustion, and a compressor (13) fluidly connected to the internal combustion engine and the adsorbed gas container (12). The compressor (13) may be adapted remove gas from the adsorbed gas container (12). A control system (14) may be communicatively coupled to the compressor (13) to modulate an engine supply pressure, Pₑ, to the internal combustion engine. In some embodiments, the controller (14) may be connected to a pressure sensor (18) adapted to measure the engine supply pressure, Pₑ. The controller (14) may also be connected to a pressure sensor (17) for measuring a storage system pressure, Pₛ, and connected to a temperature sensor (16) for measuring a temperature of the storage system, Tₛ. In some embodiments, more or less sensors may be included as would be appreciated by one of ordinary skill in the art. The system may also include an inlet (15) that fluidly connects a gas fill line to the adsorbed gas container and the compressor.

In one embodiment, the compressor can modulate the pressure of the adsorbed gas container during filling. In another embodiment, the system includes an additional compressor for modulating the pressure of the adsorbed gas container during filling. The additional compressor can be on board a vehicle or external to a vehicle.

In certain embodiments, the fuel system further includes a fuel injector in fluid connection between the engine and the compressor. The compressor is suitable to extract adsorbed gas from the container at times of low pressure in order to provide gas at a sufficient pressure to the fuel injector for operation of the engine.

In an alternative embodiment, the system works on direct injection into the engine without the need for a fuel injector. In such an embodiment, the compressor is in fluid connection directly with the engine.

In the fuel system, the compressor is adapted to remove gas from the adsorbed gas container when the engine is running and when the container pressure is, e.g., about 250 psi or less; about 200 psi or less; about 150 psi or less; about 125 psi or less; about 100 psi or less; about 75 psi or less, or about 50 psi or less. In certain embodiments, the compressor can facilitate the removal of gas from the adsorbed gas container even when the pressure is at a relatively high pressure as compared to the values above.

In the fuel system, the compressor is adapted to maintain the pressure of compressed gas at the engine (or the fuel injector) when the engine is running at, e.g., about 250 psi or greater; about 200 psi or greater; about 150 psi or greater; or about 100 psi or greater. In certain embodiments, the compressor is adapted to maintain the pressure of compressed gas at the engine (or the fuel injector) at from about 100 psi to about 600 psi when the engine is running.

In certain embodiments, the fuel system allows for at least about 70%, at least about 80%, at least about 90%, at least about 95% or at least about 99% utilization of the adsorbed gas capacity of a filled adsorbed gas container.

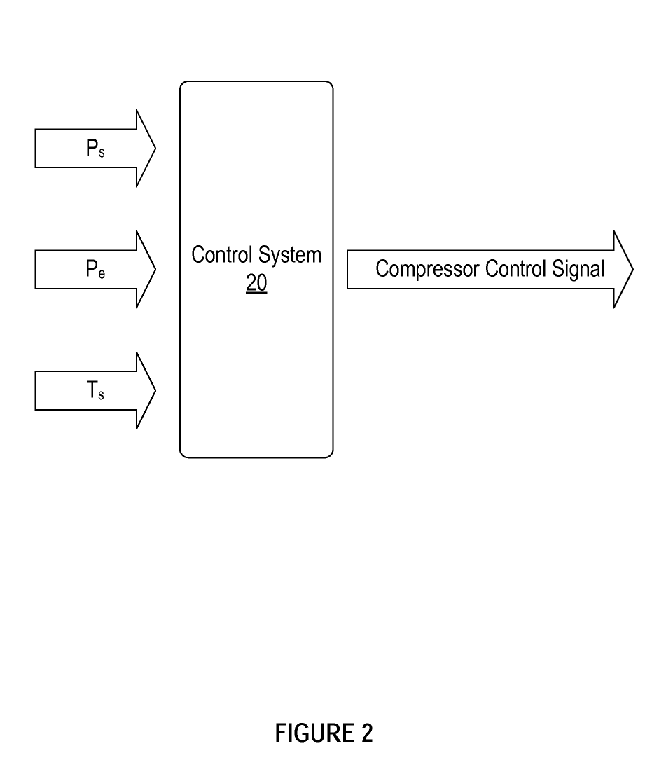

As depicted in FIG. 2, the fuel system may also include a control system (20) to modulate the supply pressure to the internal combustion engine based on one or more of storage system pressure (Pₛ), storage system temperature (Tₛ), engine supply pressure (Pₑ), additional parameters, or combinations thereof. In some embodiments, the control system (20) may be the same or similar to the controller (14) described with respect to FIG. 1.

In one embodiment, the control system modulates the supply pressure to the internal combustion engine based on Pₛ and Tₛ and utilizes Pₑ as a direct feedback signal for controllability.

The use of a compressor to modulate extraction of gas from an adsorbed gas container can be utilized in bi-fuel vehicles that utilize both gasoline and adsorbed gas as well as vehicles that solely rely upon adsorbed gas.

The use of a compressor to modulate extraction of gas from an adsorbed gas container is not limited to use with internal combustion engines. The embodiments disclosed herein can also be utilized in any machine that operates on combustible gas, e.g., an internal combustion engine, or a device that converts chemical energy from a fuel into electricity such as a fuel cell.

### Gasoline Vapor Recovery

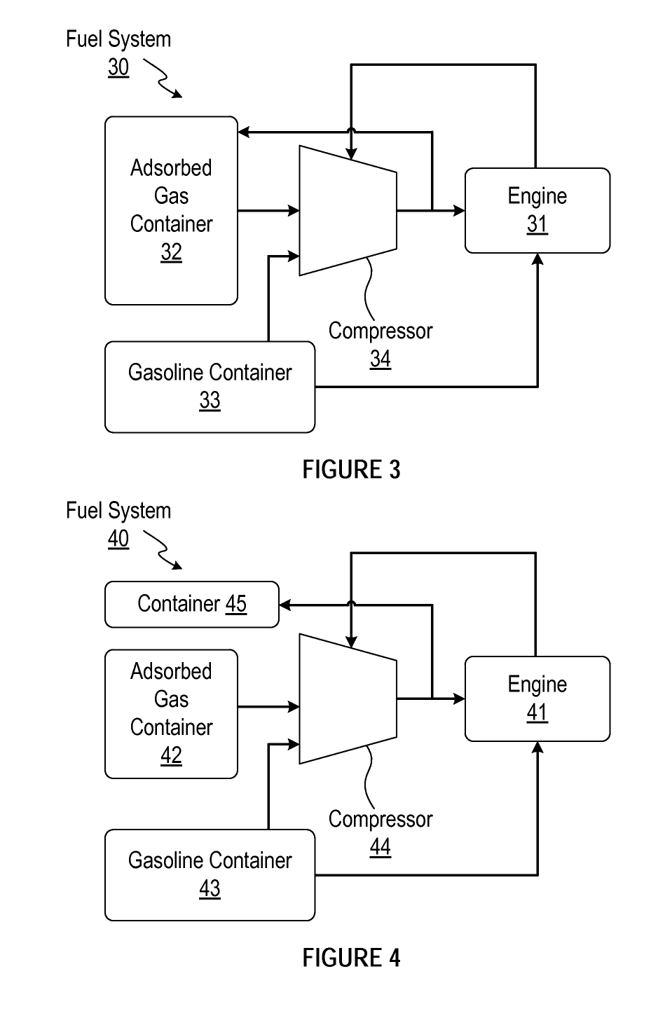

As depicted in FIG. 3, certain embodiments are directed to a fuel system (30) including an internal combustion engine (31), an adsorbed gas container (32) fluidly connected to the internal combustion engine, the adsorbed gas container containing an adsorbent; a gasoline container (33) fluidly connected to the internal combustion engine and the adsorbed gas container; and a compressor (34) capable of extracting gasoline vapor from the gasoline container and depositing the gasoline vapor into the adsorbed gas container. In some embodiments, one or more additional adsorbed gas containers may be fluidly connected between the compressor (34) and the engine (31).

As depicted in FIG. 4, certain embodiments are directed to a fuel system (40) including an internal combustion engine (41), an adsorbed gas container (42) fluidly connected to the internal combustion engine, the adsorbed gas container containing an adsorbent; a gasoline container (43) fluidly connected to the internal combustion engine and the adsorbed gas container; and a compressor (44) capable of extracting gasoline vapor from the gasoline container and depositing the gasoline vapor into an additional container (45) that optionally contains an adsorbent material. In some embodiments, one or more additional adsorbed gas containers may be fluidly connected between the compressor (44) and the engine (41).

In certain embodiments, the vapor can be deposited under pressure into the container(s) as a liquid.

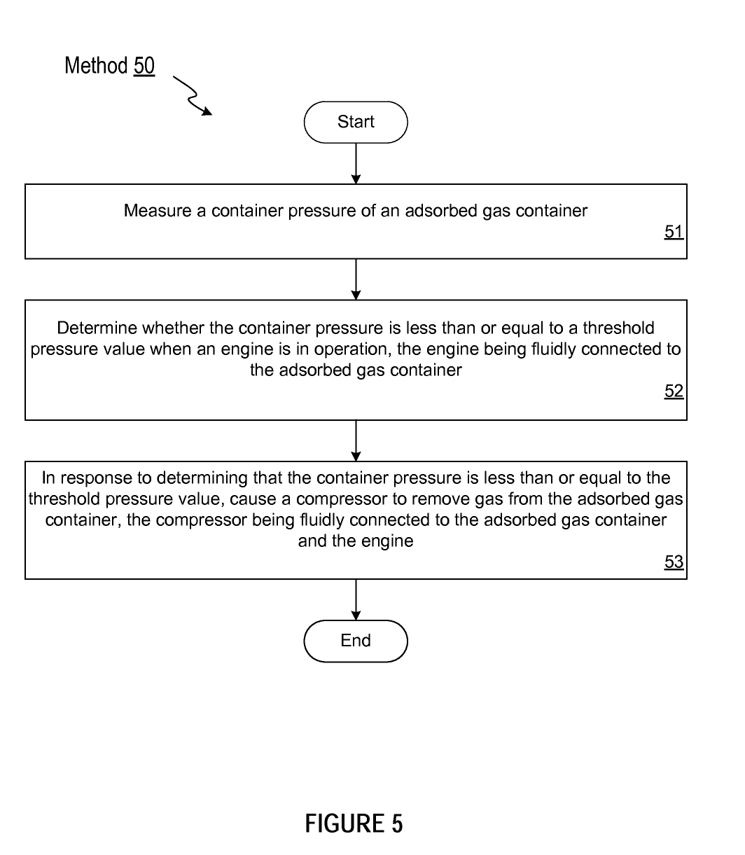

FIG. 5 is a flow diagram illustrating a method (50) for implementing a fuel system in accordance with an embodiment of the disclosure. The method (50) may be performed using any of fuel systems (10), (30), or (40). At block (51), a container pressure of an adsorbed gas container (e.g., any of adsorbed gas containers (12), (32), or (42)) is measured. For example, the container pressure may be measured using a pressure sensor (e.g., pressure sensor (17)). At block (52), a determination is made (e.g., using a controller such as controller (14) or control system (20)) as to whether the container pressure is less than or equal to a threshold pressure value when an engine (e.g., any of engines (31) or (41)) is in operation. In certain embodiments, the threshold pressure value is about 100 psi. In certain embodiments, the engine is fluidly connected to the adsorbed gas container. At block (53), in response to determining that the container pressure is less than or equal to the threshold pressure value, a compressor (e.g., any of compressors (13), (34), or (44)) is caused (e.g., by using a controller such as controller (14) or control system (20)) to remove gas from the adsorbed gas container. In certain embodiments, the compressor is fluidly connected to the adsorbed gas container and the engine.

For simplicity of explanation, the embodiments of the methods of this disclosure are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

Other embodiments are directed to a fuel system including: an internal combustion engine; a gas container optionally fluidly connected to the internal combustion engine; a gasoline container fluidly connected to the internal combustion engine and the gas container; and a compressor capable of extracting gasoline vapor from the gasoline container and depositing the gasoline vapor into the gas container. In such an embodiment, the gas container may not contain an adsorbent material and can be a compressed gas container. Alternatively, the gas container can be utilized to power the engine or can solely be used to hold the extracted material for later disposal or for alternative use.

An additional embodiment is directed to a fuel system including: an internal combustion engine; an adsorbed gas container fluidly connected to the internal combustion engine, the adsorbed gas container containing an adsorbent; a gasoline container fluidly connected to the internal combustion engine and optionally the adsorbed gas container; an additional gas container and a compressor capable of extracting gasoline vapor from the gasoline container and depositing the gasoline vapor into the additional gas container.

In certain embodiments, the engine powers the compressor when the engine is running. The fuel system of the present disclosure may also include a battery that powers the compressor when the engine is off. The battery may be external or internal to a vehicle that integrates the fuel system.

A guard bed may also be included in the systems disclosed herein. The gasoline vapor extracted from the gasoline tank by the compressor may be adsorbed into the guard bed, on the adsorbent in the container, or both. The guard bed can be incorporated into the adsorbed gas container.

The vapors extracted from the gasoline tank are typically hydrocarbon gasses such as butane but can also include other gases.

The compressor for extracting the gasoline vapor may also be capable of filling the adsorbed gas container with a gas from an external source and/or capable to remove gas from the adsorbed gas container during engine operation at times of low pressure (as disclosed above). Alternatively, one or more additional compressors can be included in the fuel system for these additional operations.

### General Fuel System Embodiments

The disclosed fuel systems (e.g., adsorbed gas extraction or gasoline vapor recovery systems) may include containers such as cylinders, tanks or any other container that is suitable for storing adsorbed gas. The container can be suitable for adsorption, containment, and/or transportation of natural gas, hydrocarbon gas (e.g., methane, ethane, butane, propane, pentane, hexane, isomers thereof and a combination thereof), air, oxygen, nitrogen, synthetic gas, hydrogen, carbon monoxide, carbon dioxide, helium, or any other gas, or combinations thereof that can be adsorbed in a container for a variety of uses. In certain embodiments, the container may be electrically grounded during filling for safety concerns. In certain embodiments, the container is adapted to contain a quantity of compressed gas to provide a range of operation for a vehicle of about 5 miles or more, of about 10 miles or more, of about 25 miles or more, of about 50 miles or more, of about 100 miles or more, or about 200 miles or more.

The fuel systems of the present disclosure can be suitable for use in a compressed gas vehicle (such as a road vehicle or an off-road vehicle) or in heavy equipment (such as generators and construction equipment). In certain embodiments, the fuel system is adapted to contain a quantity of compressed gas to provide a range of operation for a vehicle of about 100 miles or more, or about 200 miles or more.

The vehicle can have, e.g., at least 2 wheels (e.g., a motorcycle or motorized scooter), at least 3 wheels (e.g., an all-terrain vehicle), at least 4 wheels (e.g., a passenger automobile), at least 6 wheels, at least 8 wheels, at least 10 wheels, at least 12 wheels, at least 14 wheels, at least 16 wheels or at least 18 wheels. The vehicle can be, e.g., a bus, refuse vehicle, freight truck, construction vehicle, or tractor.

The adsorption container of the fuel systems can have a capacity, e.g., of at least about 1 liter, at least about 5 liters, at least about 10 liters, at least about 50 liters, at least about 75 liters, at least about 100 liters, at least about 200 liters, or at least about 400 liters. In certain embodiments, a vehicle fuel system can include multiple containers (e.g., tanks), e.g., at least 2 containers, at least 4 containers, at least 6 containers or at least 8 containers. In certain embodiment, the fuel system can contain 2 containers, 3 containers, 4 containers, 5 containers, 6 containers, 7 containers, 8 containers, 9 containers or 10 containers.

When filled into the container, the ratio of the tapped density of the particles to the ratio of the freely settled density of the particles can be greater than 1, e.g., at least about 1.1, at least about 1.2, at least about 1.5, at least about 1.7, at least about 2.0 or at least about 2.5.

The adsorbent material (e.g., particles) that may be utilized using the methods disclosed herein can be metal organic framework, e.g., having a surface area of at least about 500 m²/g, at least about 700 m²/g, at least about 1000 m²/g, at least about 1200 m²/g, at least about 1500 m²/g, at least about 1700 m²/g, at least about 2000 m²/g, at least about 5000 m²/g or at least about 10,000 m²/g.

The surface area of the material may be determined by the BET (Brunauer-Emmett-Teller) method according to DIN ISO 9277:2003-05 (which is a revised version of DIN 66131). The specific surface area is determined by a multipoint BET measurement in the relative pressure range from 0.05-0.3 p/p₀.

In certain embodiments the adsorbent material includes a zeolite. In certain embodiments a chemical formula of the zeolite is of a form of M_{x/n}[(AlO₂)ₓ(SiO₂)_{y}].mH₂O, where x, y, m, and n are integers greater than or equal to 0, and M is a metal selected from the group consisting of Na and K.

In other embodiments the adsorbent material is a zeolitic material in which the framework structure is composed of YO₂ and X₂O₃, in which Y is a tetravalent element and X is a trivalent element. In one embodiment Y is selected from the group consisting of Si, Sn, Ti, Zr, Ge, and combinations of two or more thereof. In one embodiment Y is selected from the group consisting of Si, Ti, Zr, and combinations of two or more thereof. In one embodiment Y is Si and/or Sn. In one embodiment Y is Si. In one embodiment X is selected from the group consisting of Al, B, In, Ga, and combinations of two or more thereof. In one embodiment X is selected from the group consisting of Al, B, In, and combinations of two or more thereof. In one embodiment X is Al and/or B. In one embodiment X is Al.

In certain embodiments, the metal organic framework particles may include a metal selected from the group consisting of Li, Mg, Ca, Sc, Y, Zr, V, Mn, Fe, Co, Ni, Cu, Zn, B, Al, Ti and a combination thereof. In certain embodiments, the MOF particles include a metal selected from the group consisting of Al, Mg, Zn, Cu, Zr, and a combination thereof.

In certain embodiments, the bidentate organic linker has at least two atoms which are selected independently from the group consisting of oxygen, sulfur and nitrogen via which an organic compound can coordinate to the metal. These atoms can be part of the skeleton of the organic compound or be functional groups. In certain embodiments the MOF particles include a moiety selected from the group consisting of a phenyl moiety, an imidazole moiety, an alkane moiety, an alkyne moiety, a pyridine moiety, a pyrazole moiety, an oxole moiety, and a combination thereof. In certain embodiments the MOF particles include at least one moiety selected from the group consisting of fumaric acid, formic acid, 2-methylimidazole, and trimesic acid.

As functional groups through which the abovementioned coordinate bonds can be formed, mention may be made by way of example of, in particular: OH, SH, NH₂, NH(—R—H), N(R—H)₂, CH₂OH, CH₂SH, CH₂NH₂, CH₂NH(—R—H), CH₂N(—R—H)₂, —CO₂H, COSH, —CS₂H, —NO₂, —B(OH)₂, —SO₃H, —Si(OH)₃, —Ge(OH)₃, —Sn(OH)₃, —Si(SH)₄, —Ge(SH)₄, —Sn(SH)₃, —PO₃H₂, —AsO₃H, —AsO₄H, —P(SH)₃, —As(SH)₃, —CH(RSH)₂, —C(RSH)₃, —CH(RNH₂)₂, —C(RNH₂)₃, —CH(ROH)₂, —C(ROH)₃—CH(RCN)₂, —C(RCN)₃, where R may be, for example, an alkylene group having 1, 2, 3, 4 or 5 carbon atoms, for example a methylene, ethylene, n-propylene, isopropylene, n-butylene, isobutylene, tert-butylene or n-pentylene group, or an aryl group having 1 or 2 aromatic rings, for example 2 C₆ rings, which may, if appropriate, be fused and may, independently of one another, be appropriately substituted by, in each case, at least one substituent and/or may, independently of one another, include, in each case, at least one heteroatom, for example N, O and/or S. In likewise embodiments, mention may be made of functional groups in which the abovementioned radical R is not present. In this regard, mention may be made of, inter alia, —CH(SH)₂, —C(SH)₃, —CH(NH₂)₂, CH(NH(R—H))₂, CH(N(R—H)₂)₂, C(NH(R—H))₃, C(N(R—H)₂)₃, —C(NH₂)₃, —CH(OH)₂, —C(OH)₃, —CH(CN)₂, —C(CN)₃.

The at least two functional groups can in principle be bound to any suitable organic compound as long as it is ensured that the organic compound including these functional groups is capable of forming the coordinate bond and of producing the framework.

The organic compounds which include the at least two functional groups are derived from a saturated or unsaturated aliphatic compound or an aromatic compound or a both aliphatic and aromatic compound.

The aliphatic compound or the aliphatic part of the both aliphatic and aromatic compound can be linear and/or branched and/or cyclic, with a plurality of rings per compound also being possible. The aliphatic compound or the aliphatic part of the both aliphatic and aromatic compound may include from 1 to 18, 1 to 14, 1 to 13, 1 to 12, 1 to 11, or 1 to 10 carbon atoms, for example 1, 2, 3, 4, 5, 6, 7, 8, 9 or 10 carbon atoms. For example, certain embodiments may include, inter alia, methane, adamantane, acetylene, ethylene or butadiene.

The aromatic compound or the aromatic part of the both aromatic and aliphatic compound can have one or more rings, for example two, three, four or five rings, with the rings being able to be present separately from one another and/or at least two rings being able to be present in fused form. The aromatic compound or the aromatic part of the both aliphatic and aromatic compound particularly may have one, two, or three rings. Furthermore, each ring of the compound can include, independently of one another, at least one heteroatom such as N, O, S, B, P, and/or Si. The aromatic compound or the aromatic part of the both aromatic and aliphatic compound may include one or two C₆ rings; in the case of two rings, they can be present either separately from one another or in fused form. Aromatic compounds of which particular mention may be made are benzene, naphthalene and/or biphenyl and/or bipyridyl and/or pyridyl.

The at least bidentate organic compound may be derived from a dicarboxylic, tricarboxylic or tetracarboxylic acid or a sulfur analogue thereof. Sulfur analogues are the functional groups —C(═O)SH and its tautomer and C(═S)SH, which can be used in place of one or more carboxylic acid groups.

For the purposes of the present disclosure, the term “derived” means that the at least bidentate organic compound can be present in partly deprotonated or completely deprotonated form in a MOF subunit or MOF-based material. Furthermore, the at least bidentate organic compound can include further substituents such as —OH, —NH₂, —OCH₃, —CH₃, —NH(CH₃), —N(CH₃)₂, —CN and halides. In certain embodiments, the at least bidentate organic compound may be an aliphatic or aromatic acyclic or cyclic hydrocarbon which has from 1 to 18 carbon atoms and, in addition, has exclusively at least two carboxy groups as functional groups.

For the purposes of the present disclosure, mention may be made by way of example of dicarboxylic acids, as may be used to realize any of the embodiments disclosed herein, such as oxalic acid, succinic acid, tartaric acid, 1,4-butanedicarboxylic acid, 1,4-butene-dicarboxylic acid, 4-oxopyran-2,6-dicarboxylic acid, 1,6-hexanedicarboxylic acid, decanedicarboxylic acid, 1,8-heptadecanedicarboxylic acid, 1,9-heptadecanedicarboxylic acid, heptadecanedicarboxylic acid, acetylenedicarboxylic acid, 1,2-benzenedicarboxylic acid, 1,3-benzenedicarboxylic acid, 2,3-pyridinedicarboxylic acid, pyridine-2,3-dicarboxylic acid, 1,3-butadiene-1,4-dicarboxylic acid, 1,4-benzenedicarboxylic acid, p-benzenedicarboxylic acid, imidazole-2,4-dicarboxyolic acid, 2-methylquinoline-3,4-dicarboxylic acid, quinoline-2,4-dicarboxylic acid, quinoxaline-2,3-dicarboxylic acid, 6-chloroquinoxaline-2,3-dicarboxylic acid, 4,4′-diaminophenylmethane-3,3′-dicarboxylic acid, quinoline-3,4-dicarboxylic acid, 7-chloro-4-hydroxyquinoline-2,8-dicarboxylic acid, diimidedicarboxylic acid, pyridine-2,6-dicarboxylic acid, 2-methylimidazole-4,5-dicarboxylic acid, thiophene-3,4-dicarboxylic acid, 2-isopropylimidazole-4,5-dicarboxylic acid, tetrahydropyran-4,4-dicarboxylic acid, perylene-3,9-dicarboxylic acid, perylenedicarboxylic acid, Pluriol E 200-dicarboxylic acid, 3,6-dioxa-octanedicarboxylic acid, 3,5-cyclohexadiene-1,2-dicarboxylic acid, octadicarboxylic acid, pentane-3,3-dicarboxylic acid, 4,4′-diamino-1,1′-biphenyl-3,3′-dicarboxylic acid, 4,4′-diaminobiphenyl-3,3′-dicarboxylic acid, benzidine-3,3′-dicarboxylic acid, 1,4-bis(phenylamino)benzene-2,5-dicarboxylic acid, 1,1′-binaphthyldicarboxylic acid, 7-chloro-8-methylquinoline-2,3-dicarboxylic acid, 1-anilinoanthraquinone-2,4′-dicarboxylic acid, polytetrahydrofuran-250-dicarboxylic acid, 1,4-bis(carboxymethyl)piperazine-2,3-dicarboxylic acid, 7-chloroquinoline-3,8-dicarboxylic acid, 1-(4-carboxyl)phenyl-3-(4-chloro)phenyl-pyrazoline-4,5-dicarboxylic acid, 1,4,5,6,7,7-hexachloro-5-norbornene-2,3-dicarboxylic acid, phenylindanedicarboxylic acid, 1,3-dibenzyl-2-oxoimidazolidine-4,5-dicarboxylic acid, 1,4-cyclohexanedicarboxylic acid, naphthalene-1,8-dicarboxylic acid, 2-benzoylbenzene-1,3-dicarboxylic acid, 1,3-dibenzyl-2-oxoimidazolidine-4,5-cis-dicarboxylic acid, 2,2′-biquinoline-4,4′-dicarboxylic acid, pyridine-3,4-dicarboxylic acid, 3,6,9-trioxaundecanedicarboxylic acid, hydroxybenzophenonedicarboxylic acid, Pluriol E 300-dicarboxylic acid, Pluriol E 400-dicarboxylic acid, Pluriol E 600-dicarboxylic acid, pyrazole-3,4-dicarboxylic acid, 2,3-pyrazinedicarboxylic acid, 5,6-dimethyl-2,3-pyrazinedicarboxylic acid, (bis(4-aminophenyl) ether)diimidedicarboxylic acid, 4,4′-diaminodiphenylmethanediimidedicarboxylic acid, (bis(4-aminophenyl) sulfone)diimidedicarboxylic acid, 1,4-naphthalenedicarboxylic acid, 2,6-naphthalenedicarboxylic acid, 1,3-adamantanedicarboxylic acid, 1,8-naphthalenedicarboxylic acid, 2,3-naphthalenedicarboxylic acid, 8-methoxy-2,3-naphthalenedicarboxylic acid, 8-nitro-2,3-naphthalenecarboxylic acid, 8-sulfo-2,3-naphthalenedicarboxylic acid, anthracene-2,3-dicarboxylic acid, 2′,3′-diphenyl-p-terphenyl-4,4″-dicarboxylic acid, (diphenyl ether)-4,4′-dicarboxylic acid, imidazole-4,5-dicarboxylic acid, 4(1H)-oxothiochromene-2,8-dicarboxylic acid, 5-tert-butyl-1,3-benzenedicarboxylic acid, 7,8-quinolinedicarboxylic acid, 4,5-imidazoledicarboxylic acid, 4-cyclohexene-1,2-dicarboxylic acid, hexatriacontanedicarboxylic acid, tetradecanedicarboxylic acid, 1,7-heptadicarboxylic acid, 5-hydroxy-1,3-benzenedicarboxylic acid, 2,5-dihydroxy-1,4-dicarboxylic acid, pyrazine-2,3-dicarboxylic acid, furan-2,5-dicarboxylic acid, 1-nonene-6,9-dicarboxylic acid, eicosenedicarboxylic acid, 4,4′-dihydroxydiphenylmethane-3,3′-dicarboxylic acid, 1-amino-4-methyl-9,10-dioxo-9,10-dihydro-anthracene-2,3-dicarboxylic acid, 2,5-pyridinedicarboxylic acid, cyclohexene-2,3-dicarboxylic acid, 2,9-dichlorofluorubin-4,11-dicarboxylic acid, 7-chloro-3-methylquinoline-6,8-dicarboxylic acid, 2,4-dichlorobenzophenone-2′,5′-dicarboxylic acid, 1,3-benzenedicarboxylic acid, 2,6-pyridinedicarboxylic acid, 1-methylpyrrole-3,4-dicarboxylic acid, 1-benzyl-1H-pyrrole-3,4-dicarboxylic acid, anthraquinone-1,5-dicarboxylic acid, 3,5-pyrazoledicarboxylic acid, 2-nitrobenzene-1,4-dicarboxylic acid, heptane-1,7-dicarboxylic acid, cyclobutane-1,1-dicarboxylic acid, 1,14-tetradecanedicarboxylic acid, 5,6-dehydronorbornane-2,3-dicarboxylic acid, 5-ethyl-2,3-pyridinedicarboxylic acid or camphordicarboxylic acid, tricarboxylic acids such as 2-hydroxy-1,2,3-propanetricarboxylic acid, 7-chloro-2,3,8-quinolinetricarboxylic acid, 1,2,3-, 1,2,4-benzenetricarboxylic acid, 1,2,4-butanetricarboxylic acid, 2-phosphono-1,2,4-butanetricarboxylic acid, 1,3,5-benzenetricarboxylic acid, 1-hydroxy-1,2,3-propanetricarboxylic acid, 4,5-dihydro-4,5-dioxo-1H-pyrrolo[2,3-F]quinoline-2,7,9-tricarboxylic acid, 5-acetyl-3-amino-6-methylbenzene-1,2,4-tricarboxylic acid, 3-amino-5-benzoyl-6-methylbenzene-1,2,4-tricarboxylic acid, 1,2,3-propanetricarboxylic acid or aurintricarboxylic acid, or tetracarboxylic acids such as 1,1-dioxidoperylo[1,12-BCD]thiophene-3,4,9,10-tetracarboxylic acid, perylene-tetracarboxylic acids such as perylene-3,4,9,10-tetracarboxylic acid or (perylene 1,12-sulfone)-3,4,9,10-tetracarboxylic acid, butanetetracarboxylic acids such as 1,2,3,4-butanetetracarboxylic acid or meso-1,2,3,4-butanetetracarboxylic acid, decane-2,4,6,8-tetracarboxylic acid, 1,4,7,10,13,16-hexaoxacyclooctadecane-2,3,11,12-tetracarboxylic acid, 1,2,4,5-benzenetetracarboxylic acid, 1,2,11,12-dodecanetetracarboxylic acid, 1,2,5,6-hexanetetracarboxylic acid, 1,2,7,8-octanetetracarboxylic acid, 1,4,5,8-naphthalenetetracarboxylic acid, 1,2,9,10-decanetetracarboxylic acid, benzophenone-tetracarboxylic acid, 3,3′,4,4′-benzophenonetetracarboxylic acid, tetrahydrofurantetracarboxylic acid or cyclopentanetetracarboxylic acids such as cyclopentane-1,2,3,4-tetracarboxylic acid.

Certain embodiments may use at least monosubstituted aromatic dicarboxylic, tricarboxylic or tetracarboxylic acids which have one, two, three, four or more rings and in which each of the rings can include at least one heteroatom, with two or more rings being able to include identical or different heteroatoms. For example, certain embodiments may use one-ring dicarboxylic acids, one-ring tricarboxylic acids, one-ring tetracarboxylic acids, two-ring dicarboxylic acids, two-ring tricarboxylic acids, two-ring tetracarboxylic acids, three-ring dicarboxylic acids, three-ring tricarboxylic acids, three-ring tetracarboxylic acids, four-ring dicarboxylic acids, four-ring tricarboxylic acids and/or four-ring tetracarboxylic acids. Suitable heteroatoms are, for example, N, O, S, B, and/or P. Suitable substituents which may be mentioned in this respect are, inter alia, —OH, a nitro group, an amino group or an alkyl or alkoxy group.

In certain embodiments, the linker may include a moiety selected from the group consisting of a phenyl moiety, an imidazole moiety, an alkane moiety, an alkyne moiety, a pyridine moiety, a pyrazole moiety, an oxole moiety and a combination thereof. In a particular embodiment, the linker may be a moiety selected from any of the moieties illustrated in Table 1.

TABLE 1
Linker Moieties

| | |
|---|---|
| Moiety 1 | 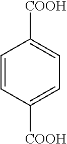 [SMILES: O=C(O)c1ccc(C(=O)O)cc1] |
| Moiety 2 | 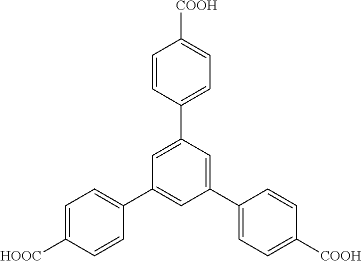 [SMILES: O=C(O)c1ccc(-c2cc(-c3ccc(C(=O)O)cc3)cc(-c3ccc(C(=O)O)cc3)c2)cc1] |
| Moiety 3 | 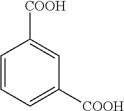 [SMILES: O=C(O)c1cccc(C(=O)O)c1] |
| Moiety 4 | 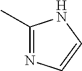 |
| Moiety 5 | 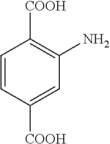 [SMILES: Nc1cc(C(=O)O)ccc1C(=O)O] |
| Moiety 6 | 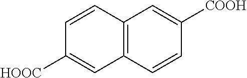 [SMILES: O=C(O)c1ccc2cc(C(=O)O)ccc2c1] |
| Moiety 7 | 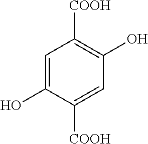 [SMILES: O=C(O)c1cc(O)c(C(=O)O)cc1O] |
| Moiety 8 | 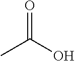 |
| Moiety 9 | 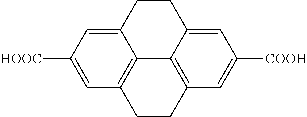 [SMILES: O=C(O)c1cc2c3c(c1)CCc1cc(C(=O)O)cc(c1-3)CC2] |
| Moiety 10 | 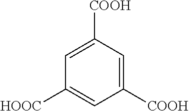 [SMILES: O=C(O)c1cc(C(=O)O)cc(C(=O)O)c1] |
| Moiety 11 | 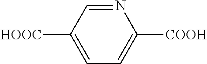 [SMILES: O=C(O)c1ccc(C(=O)O)nc1] |
| Moiety 12 | 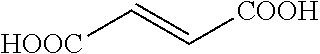 |
| Moiety 13 | 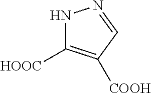 [SMILES: O=C(O)c1cn[nH]c1C(=O)O] |
| Moiety 14 | 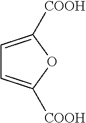 [SMILES: O=C(O)c1ccc(C(=O)O)o1] |
| Moiety 15 | 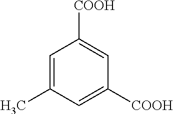 |

The MOF particles can be in any form, such as, e.g., pellets, extrudates, beads, powders or any other defined or irregular shape. The particles can be any size, e.g., from about 0.0001 mm to about 10 mm, from about 0.001 mm to about 5 mm, from about 0.01 mm to about 3 mm, or from about 0.1 mm to about 1 mm.

One embodiment is directed to the fuel systems disclosed herein with a containment system including a container suitable for adsorbed gas storage having a capacity of at least 1 liter at least partially filled with metal organic framework particles such that the ratio of the tapped density of the particles to the ratio of the freely settled density of the particles is at least 1.1. Still further embodiments are directed to vehicles including the fuel systems as disclosed herein. Other embodiments are directed to methods of manufacturing such vehicles by integrating a fuel system as disclosed herein into a vehicle.

The disclosed fuels systems can be part of an assembly of a new vehicle or can be retrofitted into an existing vehicle. Also disclosed herein are methods of operating a vehicle including controlling the amount of gas being utilized by a vehicle including a fuel system as disclosed herein.

### Methods of Filling Containers

In certain embodiments, the fuel systems can include a container suitable for adsorbed gas storage having a capacity of at least 1 liter and at least partially filled with metal organic framework particles such that (i) the ratio of the tapped density of the particles to the ratio of the freely settled density of the particles greater than 1 (e.g., 1.1 or more) or (ii) the tapped density is, depending on the selection of materials, e.g., from about 0.1 g/cm³ to about 10 g/cm³, from about 0.2 g/cm³ to about 5 g/cm³, from about 0.3 g/cm³ to about 0.8 g/cm³ or from about 0.2 g/cm³ to about 1 g/cm³.

The filling process may include shifting or moving (intermittently or constantly) the container during at least a portion of the filling. Alternatively, or in addition, the filling may include shifting or moving the container after the filling with the metal organic framework particles. The shifting or moving of the container may include, e.g., shaking, rolling, vibrating or subjection to centrifugal force. The filling process may also include the use of a tube to transfer the metal organic framework particles from a storage vessel to the container. The tube can be any suitable dimension such as, e.g., an elongated cylinder. A funnel may also be utilized in the filling process. The funnel can be incorporated as an integral part of the tube or can be a separate apparatus that is connected with the tube.

During the filling process, the container can be positioned such that the stream of particles during the filling is downward. In a particular embodiment, the stream of particles during the filling is downward at any suitable angle to effect filling, e.g., at an angle of between about 135° and about 225° from a vertical axis.

In order to minimize the exposure of filling material to contaminants, the tube can be sealed to the container inlet during the filling, sealed to the storage vessel outlet during the filling or sealed to both the container inlet and the storage vessel outlet during the filling.

In certain embodiments, the tube is at an initial position at the start of the filling and the tube is raised upward to a second position at the end of the filling. The tube may be raised intermittently or constantly from the initial position to the second position during the filling. Further, the tube may be raised at a fixed rate or at a varied rate from the initial position to the second position during the filling. In still further embodiments, the tube is raised linearly or non-linearly (e.g., in a circular or corkscrew manner) from the initial position to the second position during the filling.

The filling process may also use a deflector within or in proximity of the inlet of the container in order to maximize the distribution of the particles within the container.

One or more steps of the filling process may also be performed under an inert atmosphere (e.g., nitrogen) in order to minimize exposure of the materials to contaminants.

The filling process may also include the manipulation of the particles in order to facilitate the process. Such manipulations may include, e.g., surface roughness control, low friction coatings, electrostatic charge reduction, or any other suitable parameters that may facilitate loading.

In certain embodiments, the metal organic framework particles can be incorporated into a matrix material and thereafter introduced into a container. The matrix may be a plastic material in any suitable form such as a sheet which can be formed, e.g., by extrusion. The material can be optionally corrugated. The material can be rolled or otherwise manipulated and incorporated into a container. Prior to introduction into a container, the material can be bound by polymer fibers.

### Activation of Particles

The disclosed fuel systems can include activated adsorption particles (e.g., metal organic framework particles) wherein the adsorption particles are subjected to conditions selected from the group consisting of above ambient temperature, vacuum, an inert gas flow and a combination thereof, for a sufficient time to activate the particles.

In certain embodiments, the activation includes the removal of water molecules from the adsorption sites. In other embodiments, the activation includes the removal of non-aqueous solvent molecules from the adsorption sites that are residual from the manufacture of the particles. In still further embodiments, the activation includes the removal of sulfur compounds or higher hydrocarbons from the adsorption sites. In embodiments utilizing an inert gas purge in the activation process, a subsequent solvent recovery step is also contemplated. In certain embodiments, the contaminants (e.g., water, non-aqueous solvents, sulfur compounds or higher hydrocarbons) are removed from the adsorption material at a molecular level.

In a particular embodiment, the activation includes the removal of water molecules from the surface area of the particles. After activation, the particles may have a moisture content of less than about 10%, less than about 8%, less than about 5%, less than about 3%, less than about 1%, less than about 0.8%, less than about 0.5%, less than about 0.3% or less than about 0.1% by weight of the particles. Alternatively, the available surface area of the adsorption material for adsorption of the intended gas is greater than about 80%, greater than about 85%, greater than about 90%, greater than about 95% or greater than about 98% of the accepted value (i.e., the theoretical surface area free of adsorbed contaminants).

The activation can occur before or after the particles are filled into a container suitable for adsorbed gas storage. Alternatively, the particles may be removed and activated external to a container suitable. Activating particles outside of the container may be beneficial in certain circumstances as the container may have temperature limitations that may impede the activation process. The external process may also result in a shorter activation time due to the ability to apply a higher temperature to the particles outside of the tank.

Certain embodiments are directed to the activation of metal organic framework particles. The particles can be subject to a suitable temperature for removal of contaminants (e.g., water, non-aqueous solvents, sulfur compounds and higher hydrocarbons) from adsorption sites. The activation may include exposure of the metal organic framework particles to a temperature, e.g., above about 40° C., above about 60° C., above about 100° C., above about 150° C., above about 250° C., or above about 350° C. In other embodiments, the temperature may be between about 40° C. and about 400° C., between about 60° C. and about 250° C., between about 100° C. and about 200° C., between about 60° C. and about 200° C., between about 60° C. and about 180° C., between about 60° C. and about 170° C., between about 60° C. and about 160° C., between about 150° C. and about 200° C. or between about 150° C. and about 180° C.

The activation of particles may be subject to a vacuum in order to remove contaminants (e.g., water, non-aqueous solvents, sulfur compounds and higher hydrocarbons) from adsorption sites. The vacuum may be, e.g., from about 10% to about 80% below atmospheric pressure, from about 10% to about 50% below atmospheric pressure, from about 10% to about 20% below atmospheric pressure, from about 20% to about 30% below atmospheric pressure or from about 30% to about 40% below atmospheric pressure.

The activation of the particles can also include flowing inert gas through the material to remove contaminants (e.g., water, non-aqueous solvents, sulfur compounds and higher hydrocarbons). The inert gas flow can include nitrogen or a noble gas. The total amount of inert gas used in the purge can be any suitable amount to activate the materials. In a particular embodiment, the amount of gas is at least the volume of a container holding the particles. In other embodiments, the amount of gas is at least 2 times the container volume or at least 3 times the container volume. The inert gas can be flowed through the materials for any suitable time, such as at least about 1 hour, at least about 6 hours, at least about 8 hours, at least about 16 hours, at least about 24 hours or at least about 48 hours. Alternatively, the time can be from about 1 hour to about 48 hours, from about 2 hours to about 24 hours or from about 4 hours to about 16 hours.

Any amount of adsorbent material (e.g., MOF particles) may be activated according to the methods described herein, or a combination thereof. In a particular embodiment, the particles may be in an amount of at least about 1 kg, at least about 500 kg, from about 20 kg to about 500 kg, from about 50 kg to about 300 kg or from about 100 kg to about 200 kg. In another embodiment, the adsorbent material may be in an amount of at least about 1 g, at least about 500 g, from about 20 g to about 500 g, from about 50 g to about 300 g, from about 100 g to about 200 g, or greater than 500 g.

The activated particles can be at least partially filled into a container suitable for compressed gas storage, e.g., having a capacity of at least about 1 liter. The filling can optionally encompass any of the filling procedures disclosed herein. The filling of activated particles may also result in the tapped density of particles disclosed herein.

After the particles are filled into a suitable adsorption container, the activation can occur by placing the container in an oven. Alternatively, if the container is mounted onto a vehicle or machinery (e.g., a generator), a heat source internal to the vehicle or machinery can be used. For example, the heat source in a vehicle may be derived from the battery, engine, air conditioning unit, brake system, or a combination thereof. In alternative embodiments, the container at least partially filled with particles can be activated with an external heat source.

In other embodiments, if the container is mounted onto a vehicle or machinery, a vacuum source internal or external to the vehicle or machinery can be used for activation. For example, the energy source in a vehicle for the internal vacuum may be derived from the battery, engine, air conditioning unit, brake system, or a combination thereof.

In embodiments wherein the container is mounted onto a vehicle or machinery, it may be necessary at a point in time after the initial activation to re-activate the particles. For instance, after one or more cycles wherein the container is filled with a compressed gas with subsequent release (e.g., upon running the vehicle), certain contaminants may remain on the adsorption sites. These contaminants may include sulfur compounds or higher hydrocarbons (e.g., C₄₋₆ hydrocarbons). The reactivation can include subjecting the particles in the container to heat, vacuum and/or inert gas flow for a sufficient time for reactivation. In one embodiment, the reactivation can occur at a service visit or can be performed at a standard fueling station. The reactivation can also include washing and/or extraction of the particles in the container with non-aqueous solvent or water.

The time period for the activation or reactivation of the particles can be determined by measuring the flow of water or non-aqueous solvent in a vacuum. In a certain embodiment, the flow is terminated when the water or solvent content is less than about 10%, less than about 8%, less than about 5%, less than about 3%, less than about 1%, less than about 0.8%, less than about 0.5%, less than about 0.3% or less than about 0.1% by weight of the particles.

In certain embodiments, the container can include a heating element in order to provide activation of the materials after filling. The energy for the heating element can be provided internally from the vehicle (e.g., from a battery, engine, air conditioning unit, brake system, or a combination thereof) or externally from the vehicle. Whether the activation is before or after filling, the container may be dried prior to the introduction of particles into the container. The container can be dried, e.g., with air, ethanol, heat or a combination thereof.

When the particles are activated outside of the container, it may be necessary to store and/or ship the particles prior to incorporation into an adsorption container. In certain embodiments, the activated particles are stored in a plastic receptacle with an optional barrier layer between the receptacle and the particles. The barrier layer may include, e.g., one or more plastic layers.

When the particles are activated by an inert gas flow, the flow may be initiated at an inlet of the container and may be terminated at an outlet of the container at a different location than the inlet. In alternative embodiments, the inert gas flow is initiated and terminated at the same location on the container.

The inert gas flow may include the utilization of a single tube for introducing and removing the inert gas from the container. In such an embodiment, the tube may include an outer section with at least one opening to allow the inert gas to enter the container and an inner section without openings to allow for the inert gas to be removed from the container. In other embodiments, the flow may include the utilization of a first tube for introducing the inert gas into the container and a second tube to remove the inert gas from the container.

Disclosure herein specifically directed to metal organic framework is also contemplated to be applicable to other adsorbent materials such as activated alumina, silica gel, activated carbon, molecular sieve carbon, zeolites (e.g., molecular sieve zeolites), polymers, resins and clays.

Also, disclosure herein with respect to adsorbent particles is also contemplated to be applicable to monoliths of the material where applicable.

In the foregoing description, numerous specific details are set forth, such as specific materials, dimensions, processes parameters, etc., to provide a thorough understanding of the present invention. The particular features, structures, materials, or characteristics may be combined in any suitable manner in one or more embodiments. The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Reference throughout this specification to “an embodiment”, “certain embodiments”, or “one embodiment” means that a particular feature, structure, or characteristic described in connection with the embodiment is included in at least one embodiment. Thus, the appearances of the phrase “an embodiment”, “certain embodiments”, or “one embodiment” in various places throughout this specification are not necessarily all referring to the same embodiment.

The present invention has been described with reference to specific exemplary embodiments thereof. It will, however, be evident that various modifications and changes may be made thereto without departing from the broader scope of the embodiments of the invention as set for in the appended claims. The specification and drawings are, accordingly, to be regarded in an illustrative rather than a restrictive sense.

1. An adsorbed gas fuel system comprising:
an internal combustion engine;
an adsorbed gas container fluidly connected to the internal combustion engine, the adsorbed gas container containing an adsorption material; and
a compressor fluidly connected to the internal combustion engine and the adsorbed gas container, the compressor adapted to remove gas from the adsorbed gas container; and
a control system to modulate a supply pressure (Pₑ) to the internal combustion engine.

2. The fuel system of claim 1, further comprising a fuel injector in fluid connection between the engine and the compressor.

3. The fuel system of claim 1, wherein the compressor is adapted to remove gas from the adsorbed gas container when a container pressure of the adsorbed gas container is about 150 psi or less when the engine is running.

4. (canceled)

5. (canceled)

6. The fuel system of claim 1, wherein the compressor is adapted to maintain a pressure of compressed gas at the engine at about 100 psi or greater when the engine is running.

7-9. (canceled)

10. The fuel system of claim 1, which allows for at least a 70% utilization of an adsorbed gas capacity of a filled adsorbed gas container.

11. (canceled)

12. (canceled)

13. The fuel system of claim 1, wherein the control system modulates the supply pressure to the internal combustion engine based on a parameter selected from the group consisting of a storage system pressure (Pₛ), a storage system temperature (Tₛ), and Pₑ.

14. The fuel system of claim 13, wherein the control system modulates the supply pressure to the internal combustion engine based on Pₛ and Tₛ.

15. The fuel system of claim 14, wherein the control system utilizes Pₑ as a direct feedback signal for controllability.

16. (canceled)

17. The fuel system of claim 1, further comprising a gas fill line fluidly connected to the adsorbed gas container and the compressor.

18. (canceled)

19. (canceled)

20. The fuel system of claim 1, adapted to contain a quantity of compressed gas to provide a range of operation for a vehicle of about 100 miles or more.

21. (canceled)

22. The fuel system of claim 17, wherein the compressor modulates the pressure of the adsorbed gas container during filling.

23. The fuel system of claim 17, further comprising an additional compressor for modulating the pressure of the adsorbed gas container during filling.

24. The fuel system of claim 1, integrated with a vehicle.

25-30. (canceled)

31. The fuel system of claim 1, wherein the adsorption material comprises metal organic framework particles that are optionally activated.

32. The fuel system of claim 31, wherein the container has a capacity of at least about 5 liters.

33-43. (canceled)

44. The fuel system of claim 31, wherein the metal organic framework particles have a surface area of at least about 500 m²/g.

45-50. (canceled)

51. The fuel system of claim 31, wherein the metal organic framework particles comprise a metal selected from the group consisting of Li, Mg, Ca, Sc, Y, Zr, V, Mn, Fe, Co, Ni, Cu, Zn, B, Al, Ti, and a combination thereof.

52. The fuel system of claim 31, wherein the metal organic framework particles comprise a moiety selected from the group consisting of a phenyl moiety, an imidazole moiety, a pyridine moiety, a pyrazole moiety, an oxole moiety, and a combination thereof.

53. (canceled)

54. (canceled)

55. A vehicle comprising the fuel system of claim 1.

56. A method of manufacturing a vehicle comprising integrating the fuel system of claim 1.

57. (canceled)

58. (canceled)

59. A method of operating a vehicle comprising controlling an amount of gas being utilized by a road vehicle comprising the fuel system of claim 1.
